(19) United States
(12) Patent Application Publication
(10) Pub. No.: US 2021/0380857 A1
(43) Pub. Date: Dec. 9, 2021

(54) SUPPORTED ABRASIVE PARTICLES, ABRASIVE ARTICLES, AND METHODS OF MAKING THE SAME

(71) Applicant: 3M Innovative Properties Company, Saint. Paul, MN (US)

(72) Inventors: Yuyang LIU, St. Paul, MN (US); Chainika JANGU, Mountain View, CA (US); Negus B. ADEFRIS, St. Paul, MN (US); Ernest L. THURBER, Somerset, WI (US); Bradford B. WRIGHT, Woodbury, MN (US); Geoffrey I. WILSON, Woodbury, MN (US); Junting LI, Woodbury, MN (US); Amelia W. KOENIG, Minneapolis, MN (US); Steven J. KEIPERT, Houlton, WI (US)

(21) Appl. No.: 17/250,983

(22) PCT Filed: Oct. 1, 2019
(86) PCT No.: PCT/IB2019/058349

§ 371 Date: Apr. 7, 2021

Related U.S. Application Data
(60) Provisional application No. 62/744,382, filed on Oct. 11, 2018.

(51) Int. Cl. C09K 3/14

(52) U.S. Cl. CPC C09K 3/1409; C09K 3/1436

(57) ABSTRACT

A plurality of supported abrasive particles wherein each supported abrasive particle respectively comprises an abrasive platelet member having a major surface and having at least one crushed support member securely bonded to and proximate the major surface. Abrasive articles containing the supported abrasive particles, and methods of making supported abrasive particles are also disclosed.

### TECHNICAL FIELD

The present disclosure broadly relates to abrasive particles, abrasive articles, and methods of making the same.

### BACKGROUND

Shaped abrasive particles have gained in popularity in recent years due their high performance in abrading a substrate. Many shaped abrasive particles are platelets (e.g., triangular platelets) whose orientation during abrading greatly influences the abrading performance. In the case of coated abrasive articles, it is typically desirable to have the shaped abrasive particles positioned in an outwardly manner so that cutting points are available to abrade a workpiece.

However, due to their thin shape, they tend to fall over and lay flat during manufacture, instead. One approach to overcoming this problem is described in U.S. Pat. No. 8,728,185 B2 (Adefris) which discloses that by making shaped abrasive particles comprising a first plate and a second plate intersecting at a predetermined angle, the rake angle of one of the plates relative to the workpiece can be precisely controlled in anchor the shaped abrasive particle to the backing while the other plate contacts the workpiece at the predetermined rake angle. The shaped abrasive particles in U.S. Pat. No. 8,728,185 B2 (Adefris) are formed as unitary particles using a sol-gel molding process using a tool having microreplicated cavities corresponding to the shapes of the shaped abrasive particle produced.

### SUMMARY

The cavity shapes in U.S. Pat. No. 8,728,185 B2 (Adefris) are complex and technically difficult to machine, as well as making release from the cavities more difficult. Further there are some shapes that cannot be made by such a method. Accordingly, it would be desirable to have alternative methods that can provide new particle shapes, and that are easier to practice.

In one aspect, the present disclosure provides a plurality of supported abrasive particles wherein each supported abrasive particle respectively comprises an abrasive platelet member having a major surface and having at least one support member securely bonded to and proximate the major surface, wherein:

(i) the support member comprises a crushed abrasive particle;

(ii) the support member has a different composition than the abrasive platelet member; or (iii) both (i) and (ii).

In another aspect, the present disclosure provides an abrasive article comprising the plurality of supported abrasive particles of according to the present disclosure retained in a binder material.

In yet another aspect, the present disclosure provides a method of making a supported abrasive particle, the method comprising:

providing a flowable abrasive precursor dispersion disposed in a shaped mold cavity and having an exposed surface;

contacting a support particle or precursor thereof with the exposed surface to make a precursor supported abrasive particle;

at least partially drying the precursor supported abrasive particle to provide a dried precursor supported abrasive particle;

removing the dried precursor supported abrasive particle from the shaped mold cavity; and

sintering the dried precursor supported abrasive particle to provide the supported abrasive particle.

In yet another aspect, the present disclosure provides a method of making a supported abrasive particle, the method comprising:

providing an abrasive platelet disposed on a substrate, wherein the shaped abrasive particle has an exposed major planar surface opposite the substrate;

providing a support particle having an adhesive layer disposed on at least a portion thereof;

bonding the adhesive to the exposed major planar surface and optionally hardening the adhesive to make the supported abrasive particle.

As used herein:

the term abrasive particle refers to a particle having a Mohs hardness of at least 6 (e.g., orthoclase).

the term grinding aid refers to a material having a Mohs hardness of less than 5.5

the term shaped abrasive particle refer to an abrasive particle having a shape that is a result of a molding process used during its manufacture.

The term crushed as applied to a particle refers to a particle that is formed through a mechanical fracturing process, and specifically excludes particles that are evidently formed into shaped particles by a molding operation and then fractured. The material fractured to produce the crushed particles may be in the form of, for example, bulk abrasive material, bulk grinding aid material, or an abrasive precursor. It may also be in the form of an extruded rod or other profile or an extruded or otherwise formed sheet, for example, of abrasive material or a precursor thereof. Mechanical fracturing includes for example roll or jaw crushing as well as fracture by explosive comminution. Crushed particles have no molded faces or molded vertexes.

The term platey means resembling a platelet and/or flake that is characterized by a thickness that is less than the width and length. For example, the thickness may be less than ½, ⅓, ¼, ⅕, ⅙, 1/7, ⅛, 1/9, or even less than 1/10 of the length and/or width. Likewise, the width may be less than ½, ⅓, ¼, ⅕, ⅙, 1/7, ⅛, 1/9, or even less than 1/10 of the length.

The term proximate means in very close proximity (e.g., within 10 microns, within 25 microns, within 50 microns, within 100 microns, or even within 250 microns).

The term shaped abrasive particle refers to a ceramic abrasive particle with at least a portion of the abrasive particle having a predetermined shape that is replicated from a mold cavity used to form a precursor shaped abrasive particle which is sintered to form the shaped abrasive particle. Except in the case of abrasive shards (e.g., as described in U.S. Pat. No. 8,034,137 B2 (Erickson et al.)), the shaped abrasive particle will generally have a predetermined geometric shape that substantially replicates the mold cavity that was used to form the shaped abrasive particle. The term shaped abrasive particle as used herein excludes abrasive particles obtained by a mechanical crushing operation.

The term partially shaped in reference to a particle refers to an article that has at least one face or vertex, but less than all faces and vertexes, that is formed by a molding process.

Features and advantages of the present disclosure will be further understood upon consideration of the detailed description as well as the appended claims.

### BRIEF DESCRIPTION OF THE DRAWINGS

FIG. 1 is a schematic perspective view of an exemplary supported abrasive particle 100 according to one embodiment of the present disclosure.

FIG. 2 is a schematic perspective view of an exemplary supported abrasive particle 200 according to one embodiment of the present disclosure.

FIG. 3 is a schematic perspective view of an exemplary supported abrasive particle 300 according to one embodiment of the present disclosure.

FIG. 4 is a schematic perspective view of an exemplary supported abrasive particle 400 according to one embodiment of the present disclosure.

FIG. 5 is a schematic perspective view of an exemplary supported abrasive particle 500 according to one embodiment of the present disclosure.

FIG. 6 is an exemplary process flow diagram for making supported abrasive particles according to one embodiment of the present disclosure.

FIG. 7 is a schematic side view of a coated abrasive article 700 according to one embodiment of the present disclosure.

FIG. 8 is an optical micrograph of supported abrasive particles made in Example 1.

FIG. 9 is an optical micrograph of supported abrasive particles made in Example 2.

FIG. 10 is an optical micrograph of supported abrasive particles made in Example 3.

FIG. 11 is an optical micrograph of supported abrasive particles made in Example 4.

FIG. 12 is an optical micrograph of supported abrasive particles made in Example 5.

FIG. 13 is an optical micrograph of supported abrasive particles made in Example 6.

FIG. 14 is an optical micrograph of supported abrasive particles made in Example 7.

FIG. 15 is an optical micrograph of a coated abrasive disc made in Example 15.

FIG. 16 is a plot of mass abraded vs. cut cycle of various abrasive discs using the Grinding Test.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

Supported abrasive particles according to the present disclosure comprise an abrasive platelet member having a major surface and having at least one crushed support member securely bonded to and proximate the major surface.

The support members either directly contact (e.g., if sintered to the abrasive platelet member) or are in very close proximity to (e.g., if adhesively bonded to the abrasive platelet member) the abrasive platelet member. By themselves, the supported abrasive particles are generally free-flowing particles, although when incorporated into a cured binder they will no longer be free-flowing as individual particles. Typically, the support members are not bonded to one another except through adhesive bonding to the abrasive platelet member. Support members bonded to non-adjacent sides of the abrasive platelet member are not bonded to each other except through adhesive bonding to the abrasive platelet member. Adhesive used to bond the support member(s) to the abrasive platelet member preferably has a different composition than any binder into which the supported abrasive particles are ultimately incorporated (e.g., a make layer), although this is not a requirement.

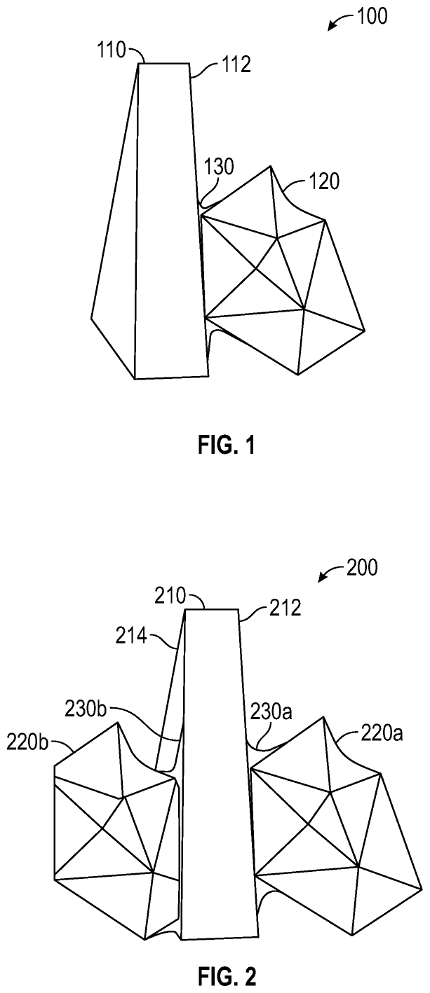

Referring now to FIG. 1, exemplary supported abrasive particle 100 comprises abrasive platelet member 110 having a major surface 112. Crushed support member 120 is secured bonded to major surface 112 by adhesive 130.

Referring now to FIG. 2, exemplary supported abrasive particle 200 comprises abrasive platelet member 210 having opposed major surfaces 212, 214. Crushed support members 220a, 220b are secured bonded to major surfaces 212, 214 by adhesives 230a, 230b.

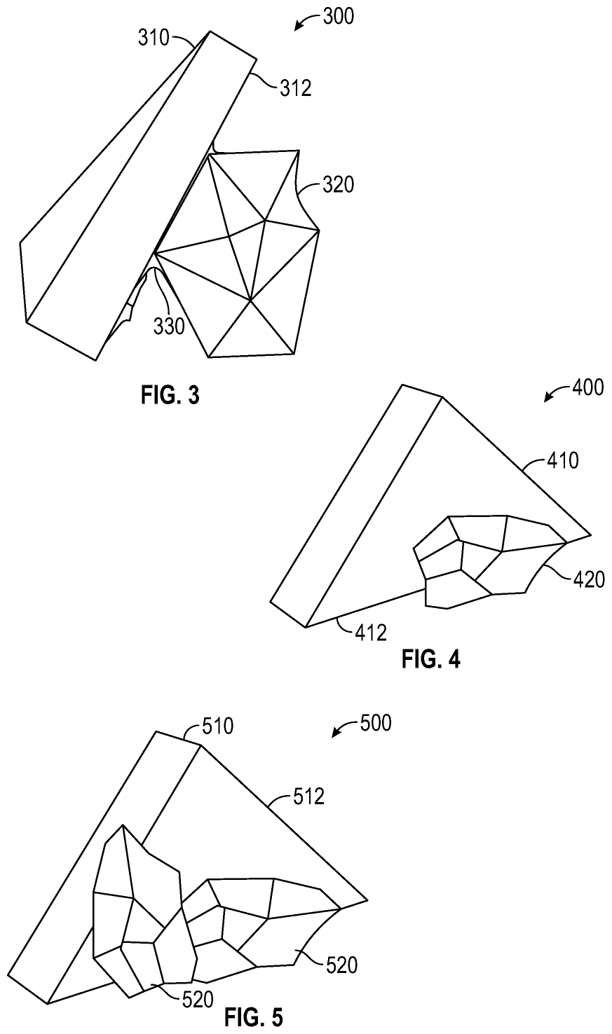

Referring now to FIG. 3, exemplary supported abrasive particle 300 comprises abrasive platelet member 310 having a major surface 312. Crushed support member 320 is secured bonded to major surface 312 by adhesive 330. Supported abrasive particle 300 is similar to supported abrasive particle 100, but differs in the resulting rake angle of the abrasive platelet member when placed on a flat surface.

Suitable platelet members have a platey and/or platelet shape and may be created from, for example, platey crushed abrasive particles and/or shaped abrasive particles. Platey and plate-like crushed abrasive particles and how to obtain them are described in WO 2016/160357 (Keipert) and U.S. Pat. No. 4,948,041 (Kruschke). Shaped abrasive platelets may be prepared, for example, by a molding process using sol-gel technology as described, for example, in U.S. Pat. No. 5,201,916 (Berg); U.S. Pat. No. 5,366,523 (Rowenhorst (Re 35,570)); U.S. Pat. No. 5,984,988 (Berg); U.S. Pat. No. 8,142,531 (Adefris et al.); and U. S. Pat. Appln. Publ. No. 2010/0146867 (Boden et al.). Exemplary shapes of abrasive platelets may include truncated pyramids (e.g., 3-, 4-, 5-, or 6-sided truncated pyramids) and prisms (e.g., 3-, 4-, 5-, or 6-sided prisms). In some embodiments (e.g., truncated pyramids and prisms), the abrasive particles respectively comprise platelets having two opposed major facets connected to each other by a plurality of side facets. The platelet member should be relatively thin as compared to their length and length. For example, the thickness may be less than ½, ⅓, ¼, ⅕, ⅙, 1/7, ⅛, 1/9, or even less than 1/10 of the length and/or width. Likewise, the width may be less than ½, ⅓, ¼, ⅕, ⅙, 1/7, ⅛, 1/9, or even less than 1/10 of the length.

The platelet member may comprise any abrasive material. Examples include, for example, fused aluminum oxide, heat treated aluminum oxide, white fused aluminum oxide, ceramic aluminum oxide materials such as those commercially available as 3M CERAMIC ABRASIVE GRAIN from 3M Company of St. Paul, Minn., black silicon carbide, green silicon carbide, titanium diboride, boron carbide, tungsten carbide, titanium carbide, cubic boron nitride, garnet, fused alumina zirconia, sol-gel derived ceramics (e.g., alumina ceramics doped with chromia, ceria, zirconia, titania, silica, and/or tin oxide), silica (e.g., quartz, glass beads, glass bubbles and glass fibers), feldspar, or flint. Of these sol-gel derived ceramic are often preferred due to their ease of shaping.

Examples of sol-gel derived abrasive particles can be found in U.S. Pat. No. 4,314,827 (Leitheiser et al.), Further details concerning methods of making sol-gel-derived abrasive particles can be found in, for example, U.S. Pat. No. 4,314,827 (Leitheiser); U.S. Pat. No. 4,623,364 (Cottringer et al.); U.S. Pat. No. 4,744,802 (Schwabel); U.S. Pat. No. 4,770,671 (Monroe et al.); U.S. Pat. No. 4,881,951 (Monroe et al.); U.S. Pat. No. 5,152,917 (Pieper et al.); U.S. Pat. No. 5,213,591 (Celikkaya et al.); U.S. Pat. No. 5,435,816 (Spurgeon et al.); U.S. Pat. No. 5,672,097 (Hoopman et al.); U.S. Pat. No. 5,946,991 (Hoopman et al.); U.S. Pat. No. 5,975,987 (Hoopman et al.); and U.S. Pat. No. 6,129,540 (Hoopman et al.); and in U. S. Publ. Pat. Appln. Nos. 2009/0165394 A1 (Culler et al.) and 2009/0169816 A1 (Erickson et al.).

The support member(s) may comprise any material. For example, the support member(s) may comprise crushed abrasive particles (e.g., comprising one or more abrasive materials as described above), grinding aid particles, or even shaped abrasive particles (especially if having a different composition than the platelet member, or adhered by an adhesive material to the platelet member, or used in a method according to the present disclosure). Useful support members may also include alumina particles that have been formed in a specific shape, then crushed to form shards that retain a portion of their original shape features as described in U.S. Pat. No. 8,034,137 (Erickson et al.).

Grinding aid particles that can be used in practice of the present disclosure have a Mohs hardness of 6 or less, preferably 5 or less, and more preferably 4 or less. Exemplary grinding aids may include inorganic halide salts, halogenated compounds and polymers, and organic and inorganic sulfur-containing materials. Exemplary grinding aids, which may be organic or inorganic, include waxes, halogenated organic compounds such as chlorinated waxes like tetrachloronaphthalene, pentachloronaphthalene, and polyvinyl chloride; halide salts such as sodium chloride, potassium cryolite, sodium cryolite, ammonium cryolite, potassium tetrafluoroborate, sodium tetrafluoroborate, silicon fluorides, potassium chloride, magnesium chloride; and metals and their alloys such as tin, lead, bismuth, cobalt, antimony, cadmium, iron, and titanium. Examples of other grinding aids include sulfur, organic sulfur compounds, graphite, and metallic sulfides, organic and inorganic phosphate-containing materials. A combination of different grinding aids may be used.

Preferred grinding aids include halide salts, particularly potassium tetrafluoroborate (KBF₄), cryolite (Na₃AlF₆), and ammonium cryolite [(NH₄)₃AlF₆]. Other halide salts that can be used as grinding aids include sodium chloride, potassium cryolite, sodium tetrafluoroborate, silicon fluorides, potassium chloride, and magnesium chloride. Other preferred grinding aids are those in U.S. Pat. No. 5,269,821 (Helmin et al.), which describes grinding aid agglomerates comprised of water soluble and water insoluble grinding aid particles. Other useful grinding aid agglomerates are those wherein a plurality of grinding aid particles are bound together into an agglomerate with a binder. Agglomerates of this type are described in U.S. Pat. No. 5,498,268 (Gagliardi et al.).

Examples of halogenated polymers useful as grinding aids include polyvinyl halides (e.g., polyvinyl chloride) and polyvinylidene halides such as those disclosed in U.S. Pat. No. 3,616,580 (Dewell et al.); highly chlorinated paraffin waxes such as those disclosed in U.S. Pat. No. 3,676,092 (Buell); completely chlorinated hydrocarbons resins such as those disclosed in U.S. Pat. No. 3,784,365 (Caserta et al.); and fluorocarbons such as polytetrafluoroethylene and polytrifluorochloroethylene as disclosed in U.S. Pat. No. 3,869,834 (Mullin et al.).

Inorganic sulfur-containing materials useful as grinding aids include elemental sulfur, cupric sulfide, molybdenum sulfide, potassium sulfate, and the like, as variously disclosed in U.S. Pat. No. 3,833,346 (Wirth), U.S. Pat. No. 3,868,232 (Sioui et al.), and U.S. Pat. No. 4,475,926 (Hickory). Organic sulfur-containing materials (e.g., thiourea) for use in the invention include those mentioned in U.S. Pat. No. 3,058,819 (Paulson).

The grinding aid particles may have an average particle size ranging from about 1 micrometer to about 100 micrometers, and more preferably ranging from about 5 micrometers to about 50 micrometers, although other sizes may be used.

In general, the support member should have an average diameter smaller than the length of the platelet member so that when the supported abrasive particle is deposited the platelet member can extends outwardly further than the support member. Otherwise the abrasive platelet member may be spaced apart from a workpiece by the support member during use.

Abrasive particles used in practice of the present disclosure may have a Mohs hardness of at least 7, preferably at least 8, and more preferably at least 9, although it may be less if a non-abrasive support member is used (e.g., a grinding aid particle) or an organic adhesive is present.

Exemplary adhesives include photo-curable adhesives, pressure-sensitive adhesives, hot-melt adhesives, thermosetting adhesives, and combinations thereof.

Exemplary photo-curable adhesives include acrylated epoxies, acrylated urethanes, acrylated silicones, and mixtures thereof.

Exemplary pressure-sensitive adhesives include latex crepe, rosin, acrylic polymers and copolymers including polyacrylate esters (e.g., poly(butyl acrylate)) polyvinyl ethers (e.g., poly(vinyl n-butyl ether)), poly(alpha-olefins), silicones, alkyd adhesives, rubber adhesives (e.g., natural rubber, synthetic rubber, chlorinated rubber), and mixtures thereof.

Exemplary thermosetting adhesives include glues, phenolic resins (e.g., resole resins and novolac resins), aminoplast resins, urea-formaldehyde resins, melamine-formaldehyde resins, one- and two-part polyurethanes, acrylic resins (e.g., acrylic monomers and oligomers, acrylated polyethers, aminoplast resins having pendant α,β-unsaturated groups, acrylated polyurethanes), epoxy resins (including bis-maleimide and fluorene-modified epoxy resins), isocyanurate resin, moisture-curable silicones, as well as mixtures thereof.

The adhesive may be organic (e.g., such as those described above) or inorganic. For example, the adhesive may be an inorganic sol (e.g., a boehmite or silica sol), that can then be dried, optionally calcined, and/or sintered to bond the support member to the abrasive platelet member. Calcining and sintering conditions will depend on the selection of inorganic adhesive, and will be within the capability of those skilled in the art.

Referring now to FIG. 4, exemplary supported abrasive particle 400 comprises abrasive platelet member 410 having a major surface 412. Crushed support member 420 is sintered to major surface 412 to form a unitary particle.

Referring now to FIG. 5, exemplary supported abrasive particle 500 comprises two abrasive platelet members 520 having a major surface 512. Crushed support members 520 are sintered to major surface 512 to form a unitary particle.

Supported abrasive particles typically have an average particle size ranging from about 0.1 to 1500 micrometers, usually between about 0.1 to 400 micrometers, preferably between 0.1 to 100 micrometers and most preferably between 0.1 to 50 micrometers, although other sizes are permissible.

In preferred embodiments the supported abrasive particles and/or the abrasive platelet members conform to an abrasives industry specified nominal grade. Exemplary abrasive industry recognized grading standards include those promulgated by ANSI (American National Standards Institute), FEPA (Federation of European Producers of Abrasives), and JIS (Japanese Industrial Standard). ANSI grade designations (i.e., specified nominal grades) include, for example: ANSI 4, ANSI 6, ANSI 8, ANSI 16, ANSI 24, ANSI 36, ANSI 46, ANSI 54, ANSI 60, ANSI 70, ANSI 80, ANSI 90, ANSI 100, ANSI 120, ANSI 150, ANSI 180, ANSI 220, ANSI 240, ANSI 280, ANSI 320, ANSI 360, ANSI 400, and ANSI 600. FEPA grade designations include F4, F5, F6, F7, F8, F10, F12, F14, F16, F16, F20, F22, F24, F30, F36, F40, F46, F54, F60, F70, F80, F90, F100, F120, F150, F180, F220, F230, F240, F280, F320, F360, F400, F500, F600, F800, F1000, F1200, F1500, and F2000. JIS grade designations include JIS8, JIS12, JIS16, JIS24, JIS36, JIS46, JIS54, JIS60, JIS80, JIS100, JIS150, JIS180, JIS220, JIS240, JIS280, JIS320, JIS360, JIS400, JIS600, JIS800, JIS1000, JIS1500, JIS2500, JIS4000, JIS6000, JIS8000, and JIS10000. According to one embodiment of the present disclosure, the average diameter of the abrasive particles may be within a range of from 260 to 1400 microns in accordance with FEPA grades F60 to F24.

Alternatively, the supported abrasive particles and/or abrasive platelet members can be graded to a nominal screened grade using U.S.A. Standard Test Sieves conforming to ASTM E-11 Standard Specification for Wire Cloth and Sieves for Testing Purposes. ASTM E-11 prescribes the requirements for the design and construction of testing sieves using a medium of woven wire cloth mounted in a frame for the classification of materials according to a designated particle size. A typical designation may be represented as −18+20 meaning that the abrasive particles pass through a test sieve meeting ASTM E-11 specifications for the number 18 sieve and are retained on a test sieve meeting ASTM E-11 specifications for the number 20 sieve. In one embodiment, the supported abrasive particles have a particle size such that most of the particles pass through an 18 mesh test sieve and can be retained on a 20, 25, 30, 35, 40, 45, or 50 mesh test sieve. In various embodiments, the supported abrasive particles can have a nominal screened grade of: −18+20, −20/+25, −25+40, −40+35, −35+40, −40+45, −45+50, −50+60, −60+70, −70/+80, −80+100, −100+120, −120+140, −140+170, −170+200, −200+230, −230+270, −270+325, −32 5+400, −400+450, −450+500, or −500+635. Alternatively, a custom mesh size can be used such as −90+100.

Supported abrasive particles according to the present disclosure can be prepared by any suitable method. Two preferred methods follow below.

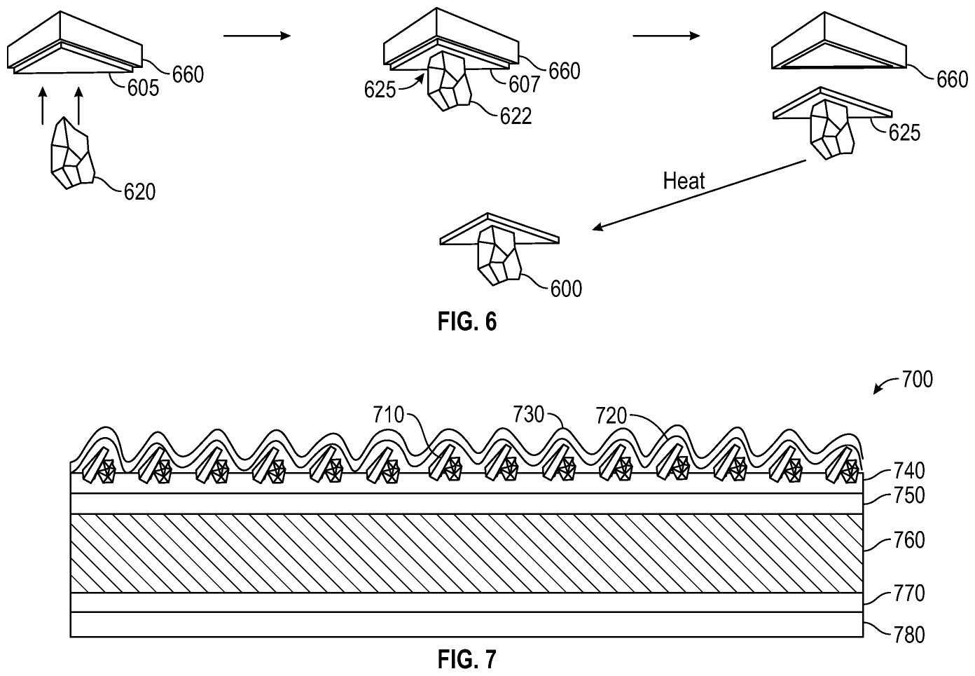

In one exemplary method, shown in FIG. 6, a flowable abrasive precursor dispersion is disposed in a shaped mold cavity. The flowable abrasive precursor dispersion in the mold cavity has an exposed surface, which is contacted with one or more support particles and/or precursors thereof to make a precursor supported abrasive particle. The precursor supported abrasive particle is then at least partially dried (preferably substantially dried) to provide a dried precursor supported abrasive particle. The dried precursor supported abrasive particle is then removed from the mold cavity, optionally calcined, and sintered to provide the supported abrasive particle. In some preferred embodiments, the exposed surface is moistened (e.g., by contact with humid air or a water mist) prior to contacting it with the support abrasive particle. The support particles may be contacted with the precursor platelet members while they are in the mold using any suitable coating technique. Drop coating and electrostatic coating (se FIG. 6) are preferred methods.

In this method, since the flowable composition that will form the abrasive platelet member is still in a precursor state, the support particle may be a precursor material, also be in a similar (or even the same) state. Thus, when the particle is fired the resultant support member will be glass or ceramic and bonded (e.g., sintered) to the abrasive platelet member. If the support particle is already ceramic, then is may sinter to the abrasive plate member during firing of the precursor supported abrasive particle. Due to the high temperatures involved in this method is no suitable for support particles that combust and/or melt at those temperatures.

In another method, an abrasive platelet is disposed on a substrate (e.g., a carrier web). The abrasive particle has an exposed major planar surface opposite the substrate. A support particle having an adhesive layer disposed on at least a portion thereof is then bonded (preferably securely bonded) to the exposed major planar surface and the adhesive optionally hardened to make the supported abrasive particle. Preferred adhesives include thermosetting organic materials and pressure-sensitive adhesives. The adhesive layer may be deposited by any suitable method, including, for example, spraying, dip coating, roll coating, and curtain coating.

In an alternative embodiment, the adhesive layer may be disposed on at least a portion of the surface of an abrasive platelet and then contacted with one or more support particles. The abrasive platelets or the support particles are preferably disposed on a substrate (e.g., a carrier web) during manufacture, although this is not a requirement.

Supported abrasive particles according to the present disclosure are useful in abrasive articles such as, for example, coated abrasive articles, nonwoven abrasive articles, and/or bonded abrasive articles, where they are retained in at least one binder material.

Referring now to FIG. 7, coated abrasive article 700 comprises backing 760. Make layer 740 is disposed on backing 760. Size layer 720 is disposed over the make layer 740 and supported abrasive particles 750 and together with make layer 740 retains supported abrasive particles 710. Optional tie layer 750 is disposed on backing 760 and contacts make layer 740. Optionally, one or more of a backsize 770, attachment layer 780, and/or supersize 730 may be included.

Abrasive articles according to the present disclosure are useful, for example, for abrading a workpiece.

### Select Embodiments of the Present Disclosure

In a first embodiment, the present disclosure provides a plurality of supported abrasive particles wherein each supported abrasive particle respectively comprises an abrasive platelet member having a major surface and having at least one support member securely bonded to and proximate the major surface, wherein:

(i) the support member comprises a crushed abrasive particle;

(ii) the support member has a different composition than the abrasive platelet member; or (iii) both (i) and (ii).

In a second embodiment, the present disclosure provides a plurality of supported abrasive particles according to the first embodiment, wherein the plurality of supported abrasive particles conform to an abrasives industry specified nominal grade.

In a third embodiment, the present disclosure provides a plurality of supported abrasive particles according to the first or second embodiment, wherein the abrasive platelet member and the at least one crushed support member have the same composition.

In a fourth embodiment, the present disclosure provides a plurality of supported abrasive particles according to any one of the first to third embodiments, wherein the abrasive platelet member and the at least one crushed support member are sintered together.

In a fifth embodiment, the present disclosure provides a plurality of supported abrasive particles according to any one of the first to fourth embodiments, wherein the at least one crushed support member comprises two crushed support members.

In a sixth embodiment, the present disclosure provides a plurality of supported abrasive particles according to any one of the first to fifth embodiments, wherein the abrasive platelet member and the at least one crushed support member have different compositions.

In a seventh embodiment, the present disclosure provides a plurality of supported abrasive particles according to the sixth embodiment, wherein the at least one crushed support member comprises a grinding aid.

In an eighth embodiment, the present disclosure provides a plurality of supported abrasive particles according to any one of the first to seventh embodiments, wherein the abrasive platelet member and the at least one crushed support member are bonded together with an adhesive.

In a ninth embodiment, the present disclosure provides a plurality of supported abrasive particles according to the eighth embodiment, wherein the adhesive comprises an organic adhesive.

In a tenth embodiment, the present disclosure provides an abrasive article comprising the plurality of supported abrasive particles of any one of the first to ninth embodiments retained in a binder material.

In an eleventh embodiment, the present disclosure provides an abrasive article according to the tenth embodiment, wherein the abrasive article comprises:

a backing;

a make layer disposed on the backing and retaining the plurality of supported abrasive particles; and

a size layer disposed over at least a portion the make layer and supported abrasive particles.

In a twelfth embodiment, the present disclosure provides a method of making a supported abrasive particle, the method comprising:

providing a flowable abrasive precursor dispersion disposed in a shaped mold cavity and having an exposed surface;

contacting a support particle or precursor thereof with the exposed surface to make a precursor supported abrasive particle;

at least partially drying the precursor supported abrasive particle to provide a dried precursor supported abrasive particle;

removing the dried precursor supported abrasive particle from the shaped mold cavity; and

sintering the dried precursor supported abrasive particle to provide the supported abrasive particle.

In a thirteenth embodiment, the present disclosure provides a method of making a supported abrasive particle according to the twelfth embodiment, further comprising humidifying the exposed surface prior to contacting it with the support abrasive particle.

In a fourteenth embodiment, the present disclosure provides a method of making a supported abrasive particle according to the twelfth or thirteenth embodiment, wherein said contacting comprises electrostatically contacting.

In a fifteenth embodiment, the present disclosure provides a method of making a supported abrasive particle according to any one of the twelfth to fourteenth embodiments, wherein the support abrasive particle is a crushed abrasive particle.

In a sixteenth embodiment, the present disclosure provides a method of making a supported abrasive particle, the method comprising:

providing an abrasive platelet disposed on a substrate, wherein the shaped abrasive particle has an exposed major planar surface opposite the substrate;

providing a support particle having an adhesive layer disposed on at least a portion thereof;
bonding the adhesive to the exposed major planar surface and optionally hardening the adhesive to make the supported abrasive particle.

In a seventeenth embodiment, the present disclosure provides a method of making a supported abrasive particle according to the sixteenth embodiment, wherein the adhesive comprises a thermosetting organic material.

In an eighteenth embodiment, the present disclosure provides a method of making a supported abrasive particle according to the sixteenth or seventeenth embodiment, wherein the support particle is crushed.

In a nineteenth embodiment, the present disclosure provides a method of making a supported abrasive particle, wherein the support particle comprises a crushed abrasive particle.

In a twentieth embodiment, the present disclosure provides a method of making a supported abrasive particle according to the nineteenth embodiment, wherein the support member comprises a grinding aid particle.

In a twenty-first embodiment, the present disclosure provides a method of making a supported abrasive particle according to the nineteenth embodiment, wherein the support member comprises a shaped abrasive particle.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

Unit Abbreviations used in the Examples:
° C.: degrees Centigrade
cm: centimeter
g: gram
g/m²: grams per square meter
rpm: revolutions per minute
mm: millimeter
wt. %: weight percent

Materials used in Examples 1-8 and Comparative Examples A-B are reported in Table 1, below.

TABLE 1

| ABBRE- | |
|---|---|
| VIATION | DESCRIPTION |
| APSG | An alumina precursor sol-gel dispersion comprising water, colloidal |
| | alumina source, and optionally peptizing agent (e.g., an acid such as |
| | nitric acid) as described in U.S. Pat. No. 6,287,353 (Celikkaya). An |
| | example of precursor sol-gel mixture was made using the following |
| | recipe: aluminum oxide monohydrate powder (1600 parts) having the |
| | trade designation DISPERAL (Sasol Chemicals North America LLC, |
| | Houston, Texas) was dispersed by high shear mixing a solution |
| | containing water (2400 parts) and 70% aqueous nitric acid (72 parts) for |
| | 11 minutes. The resulting alumina precursor sol-gel was aged for at least |
| | 1 hour before use. |
| ASD | Alumina slurry was a dispersion comprising water, non-colloidal alumina |
| | powder source, and optionally stabilizing agent and temporary binder, as |
| | described in U.S. Pat. Appl. No. 2015/0267097 A1 (Rosenflanz et al). |
| | An example of precursor slurry was made using the following recipe: A |
| | polyethylene-lined ball-mill jar was charged with 100 grams (g) of |
| | deionized water, 0.5 g of ammonium citrate dispersant agent, and 400 g |
| | of aluminum oxide powder (product ID: SPA-0.5, with Alumina oxide |
| | purity of 99.995%) from Sasol North America, Inc Sasol North |
| | America Inc., Tucson, Arizona as CERALOX. About 700 grams of |
| | alumina milling media (10 mm diameter; 99.9% alumina; obtained from |
| | Union Process, Akron, Ohio) were added to the bottle, and the mixture |
| | was milled at 120 rpm for 24 hours. After milling, the milling media was |
| | removed and the slurry was degassed by placing it into a desiccator jar |
| | and applying a vacuum using mechanical pump (about 10 minutes hold |
| | under vacuum). |
| SG-SAP | Sol-gel-derived shaped abrasive particles (SG-SAP) were prepared |
| | according to the disclosure of U.S. Pat. No. 8,142,531 (Adefris et al). |
| | The shaped abrasive particles were prepared by molding APSG in |
| | equilateral triangle-shaped polypropylene mold cavities. After drying and |
| | firing, the resulting shaped abrasive particles were about 0.18 mm (side |
| | length) × 0.04 mm thick, with a draft angle approximately 98 degrees. |
| PD-SAP | Powder-derived shaped abrasive particles (PD-SAP) were prepared |
| | according to the disclosure of U.S. Pat. Appl. No. 2015/0267097 A1 |
| | (Rosenflanz et al). The PD-SAP were prepared by molding Alumina |
| | slurry in equilateral triangle-shaped polypropylene mold cavities. After |
| | drying and firing, the resulting shaped abrasive particles were about 0.18 |
| | mm (side length) × 0.04 mm thick, with a draft angle approximately 98 |
| | degrees. |
| CDSGP | Crushed dry-gel particles made as follows: 500 g of APSG was placed in |
| | a plastic container and dried at room temperature for 1 week. Then the |
| | dried monolith was crushed in a steel mortar and with a steel pestle. The |
| | crushed particles were collected and screened by different size meshes. |
| Crushed abrasive | Unless stated otherwise, the crushed abrasive particles used in the |
| particles | examples were supplied by Washington Mills, Grafton, Massachusetts. |
| Grinding aid | Unless stated otherwise, the grinding aid particles were purchased from |
| particles | Sigma-Aldrich, Saint Louis, Missouri. |
| PVA | Polyvinyl Alcohol, Grade 5-88 with the degree of hydrolysis 86.5- |
| | 90.0%, was obtained from Kuraray America, Inc. (Houston, Texas). |
| | asPOVAL. |
| Fiber disc backing | Precut vulcanized fiber discs blanks with a diameter of 17.8 cm, a center |
| | hole of 2.2 cm and thickness of 0.83 mm were obtained as Dynos |
| | Vulcanized Fibre from DYNOS GMBH, Troisdorf, Germany. |
| PF1 | Phenol-formaldehyde resin having a phenol to formaldehyde molar ratio |
| | of 1:1.5-2.1, and catalyzed with 2.5 percent by weight potassium hydroxide. |
| PF2 | Phenol-formaldehyde resin having a phenol to formaldehyde molar ratio |
| | of 1:1.6-1.8, and catalvzed with 2.0 percent by weight sodium hydroxide. |
| ER1 | Aqueous Epoxy dispersion commercially available as EPI-REZ 3522- |
| | W60 from Hexion Specialty Chemical, Inc., Louisville, Kentucky |
| CACO | Calcium Carbonate commercially available as Hubercarb Q325 from |
| | Hubercarb Engineered Materials, Atlanta Georgia. |
| CRY | Cryolite, average particle size 250 microns, obtained as CRYOLITE |
| | RTN-C from Freebee A/S, Ullerslev, Denmark. |
| KBF4 | Potassium tetrafluoroborate, obtained as Potassium Fluoroborate Spec |
| | 101 from Atotech USA, Inc., Rockhill, South Carolina. |
| IO | Red iron oxide pigment, obtained as KROMA RO-3097 from Elementis |
| | Specialties, Inc., East Saint Louis, Illinois. |
| EC1 | 2-Ethyl-4-methyl imidazole, obtained as EMI-2,4 from Air Products, |
| | Allentown, Pennsylvania |
| Make Resin 1 | Phenolic Make Resin 1 was prepared by mixing 49.2 parts by weight of |
| | PR1; 40.6 parts by weight of CACO; and 10.2 parts by weight of |
| | deionized water. |
| Size Resin 1 | Phenolic Size Resin 1 was prepared by mixing 40.6 parts by weight of |
| | PR1; 69.9 parts by weight of CRY; 2.5 parts by weight IO; and 25 parts |
| | by weight deionized water. |
| Supersize Resin 1 | Supersize Resin 1 was prepared by mixing 29.2 parts of ER1, 1.1 parts |
| | EC1, 53.3 parts KBF4, 14.1 parts deionized water; and 2.3 parts IO. |
| Make Resin 2 | Make Resin 2 was prepared by mixing 60 parts by weight of PR1; 10 |
| | parts by weight of EC1; and 30 parts by weight of deionized water. |
| Size Resin 2 | Size Resin 2 was prepared by mixing 58 parts by weight of PR1; 7 parts |
| | by weight of EC1; and 35 parts by weight of deionized water. |

### Example 1

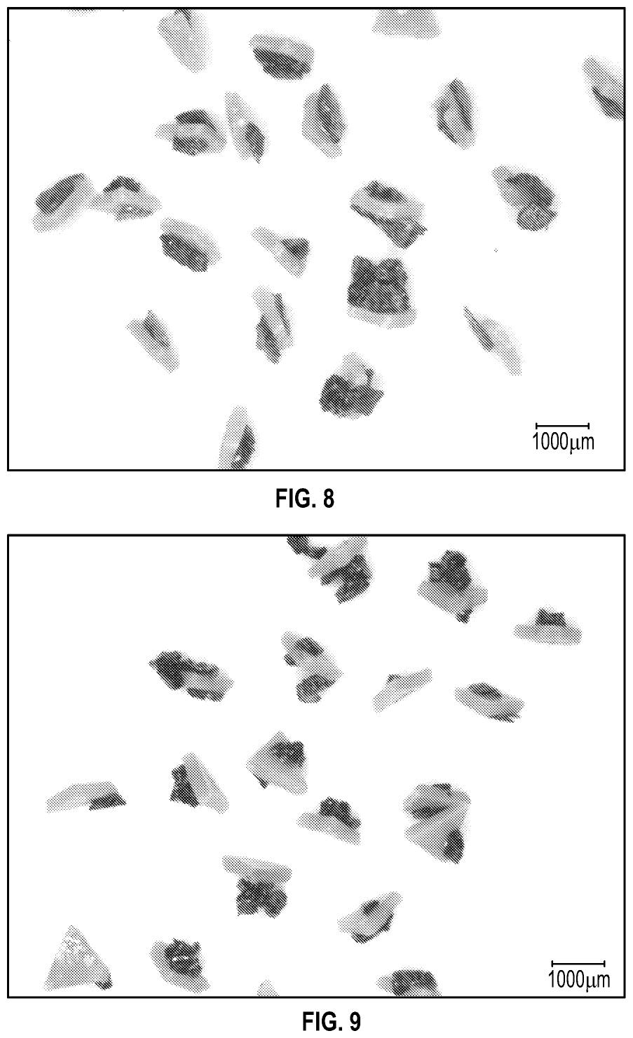

In this Example, the abrasive platelet members were P36 grade SG-SAP shaped abrasive particles; the support members were crushed P40 grade brown alumina particles; and the binder material was PF2 phenolic resin. This example was made through the following steps: (1) 20 g of PF2 was diluted with deionized water to 100 g with agitation in a plastic container; (2) 100 g of P36 grade SG-SAP shaped abrasive particles were added the solution made in step (1) and stirring was continued for 5 minutes; (3) the mixture in step (2) was filtered and the wet shaped abrasive particles (now having a coating of phenolic resin) were recovered through filtration and then placed in a plastic container; (4) 500 g of P40 grade crushed brown alumina grains were added into the plastic container and blended with the wet shaped abrasive particles; (5) the particle blend was transferred onto a plate and then dried at 105° C. for at least 20 minutes; (6) the dried particle blend was broken up in a steel mortar using a rubber pestle, and then the resulting supported abrasive particles were collected and screened by different size meshes. As the supported abrasive particles has a larger size than that of either the shaped abrasive particles or the crushed abrasive particles, they could be isolated from the blend through sieving. The dissociated grains could be screened and reused. Representative resulting supported abrasive particles are shown in FIG. 8.

### Example 2

Example 1 was repeated except that P40 grade crushed SiC grains were used as support members. Representative resulting supported abrasive particles are shown in FIG. 9.

### Example 3

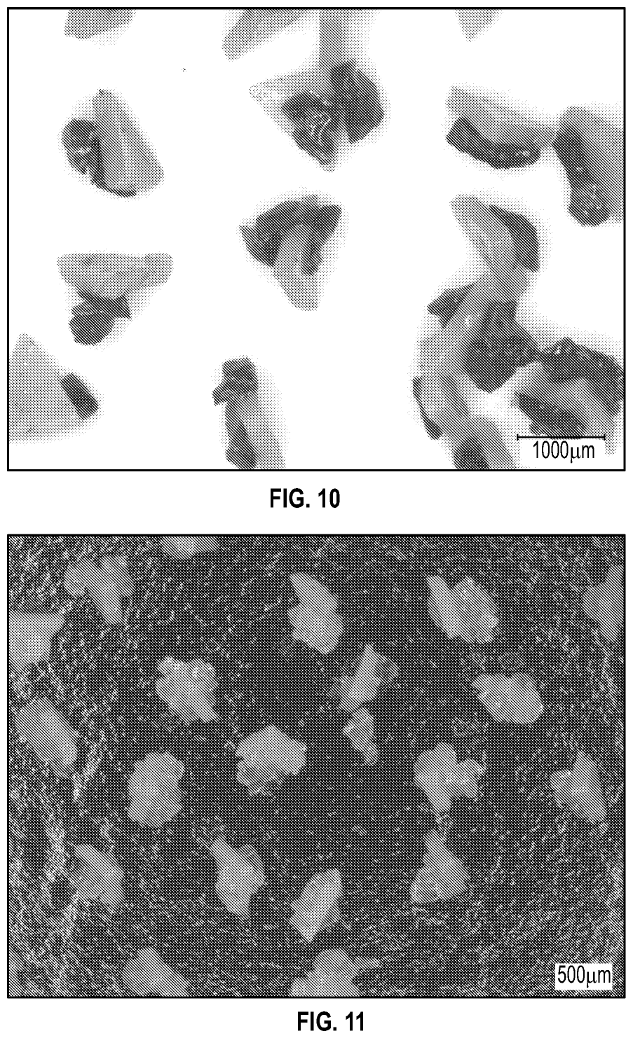

Example 1 was repeated except that P40 grade crushed AZ grains were used as support members. Representative resulting supported abrasive particles are shown in FIG. 10.

### Example 4

Example 1 was repeated except that CRY particles were used as support members and PVA was used instead of PF2. Representative resulting supported abrasive particles are shown in FIG. 11.

### Example 5

APSG was spread into the cavities of a P60 grade microreplication tool using a putty knife and dried at 50° C. for 10 minutes then removed from the tool (support member precursor). The P60 grade microreplication tool, described in U.S. Pat. No. 8,142,531 B2 (Adefris et al.), had triangular shaped mold cavities of 0.33 mm (13 mils) depth and 1.3 mm (51 mils) on each side. The draft angle α between the mold sidewall and mold bottom surface was 98 degrees.

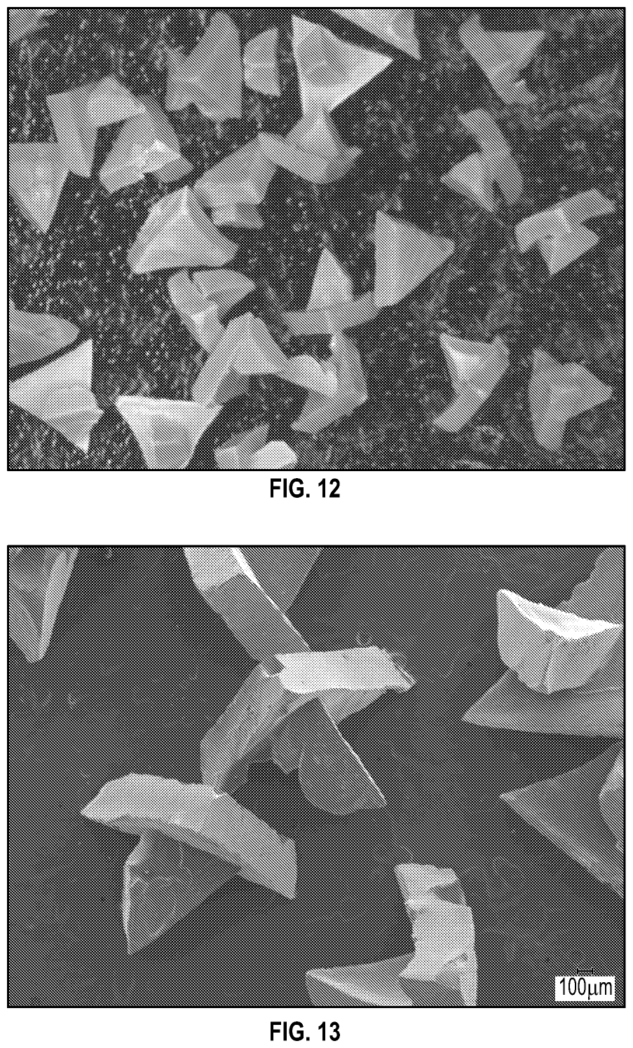

APSG was spread into the cavities of a P36 grade microreplication tool using a putty knife (abrasive platelet member precursor). The P36 grade microreplication tool had triangular shaped mold cavities of 28 mils depth and 110 mils on each side. The draft angle α between the sidewall and bottom of the mold was 90 degrees. Support member precursor particles were electrostatically coated onto the surface of the wet APSG, and together with the micro-replication tool, dried at 50° C. for 10 minutes. The precursor shaped abrasive particles were removed from the production tool by passing it over an ultrasonic horn. The precursor shaped abrasive particles were calcined at approximately 650° C. and then saturated with a mixed nitrate solution of the following concentration (reported as oxides): 1.8% each of MgO, Y₂O₃, Nd₂O₃ and La₂O₃. The excess nitrate solution was removed and the saturated precursor shaped abrasive particles with openings were allowed to dry after which the particles were again calcined at 650° C. and sintered at approximately 1400° C. Both the calcining and sintering was performed using rotary tube kilns. FIG. 12 shows supported abrasive particles made according to this example.

### Example 6

Example 5 was repeated, except that CDSGP was used as the support member precursor particles. Representative resulting supported abrasive particles are shown in FIG. 13.

### Example 7

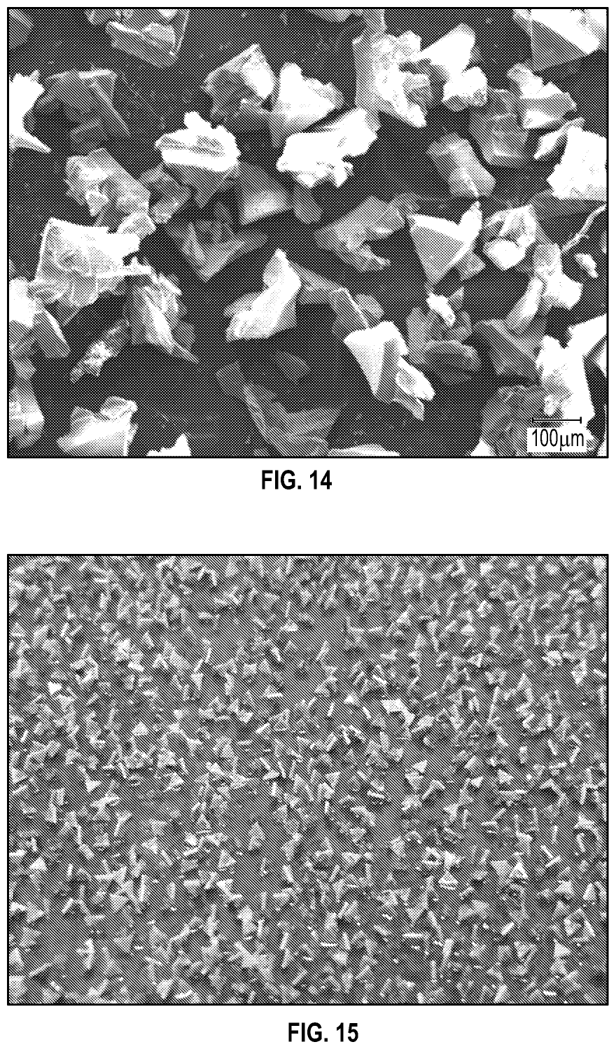

Example 5 was repeated, except that the abrasive platelet member precursors were prepared using ASD and a P220 grade microreplication tool, and P220 grade ASD was used in place of APSG, and P240 grade crushed alumina was used as the support particles. Representative resulting supported abrasive particles are shown in FIG. 14.

### Example 8

A vulcanized fiber disc blank with a diameter of 7 inches (17.8 cm), having a center hole of ⅞ inch (2.2 cm) diameter and a thickness of 0.83 mm (33 mils) was used as the abrasive substrate. The vulcanized fiber was obtained as Dynos Vulcanized Fibre from DYNOS GmbH, Troisdorf, Germany. The fiber disc blank was coated by brush with Make Resin 1 to an add-on weight of 3.0-3.1 grams.

The coated disc was weighed and abrasive particles made in Examples as indicated were applied using an electrostatic coater. The abrasive coated disc was removed and weighed to establish the quantity of abrasive particles coated. In this example, 15.0-15.1 g supported abrasive particles made in Example 1 were used. The disc was given a make pre-cure at 90° C. for 1 hour followed by 103° C. for 3 hours.

The precured discs were then coated by brush with size resin. Excess size resin was removed with a dry brush until the flooded glossy appearance was reduced to a matte appearance. The size-coated discs were weighed to establish the size resin weight. The amount of size resin added was dependent on the mineral composition and weights, but was typically between 12 and 28 grams per disc. In this example, 11.5-13.0 g of size coat was used. The discs were cured by heating for 90 minutes at 90° C., followed by 16 hours at 103° C. The cured discs were orthogonally flexed over a 1.5 inch (3.8 cm) diameter roller. Discs were allowed to equilibrate with ambient humidity for 1 week before testing. A representative disc is shown in FIG. 15.

### Comparative Example A

Comparative Example A (an abrasive article) was made following the procedure of Example 8, except that a 50-50 blend mineral (P36 grade precision shaped grains/P40 grade crushed brown alumina grains 50/50 by weight) was used in place of the supported abrasive particles.

The specific constructions of Example 8 and Comparative Example A for two replicates of each are reported in Table 2, below.

TABLE 2

| | | | | Backing + Make |
|---|---|---|---|---|
| | | Backing | Backing + Make | Layer + Abrasive |
| | | Weight, | Layer weight, | Particles weight, |
| Example | Replicate | g | g | g |
| 8 | A | 26.4 | 29.5 | 45 |
| | B | 26.4 | 29.4 | 45 |
| Comparative | 1 | 26.4 | 29.4 | 45.8 |
| Example A | 2 | 26.4 | 29.4 | 44.5 |

### Comparative Example B

A 7-inch (17.8 cm) abrasive fiber disc available as Cubitron II Fibre Disc 982C from 3M Company. Comparative Example B was similar to Example 8, except it was coated with 100% P36 grade triangular shaped abrasive particles.

### Grinding Performance Test

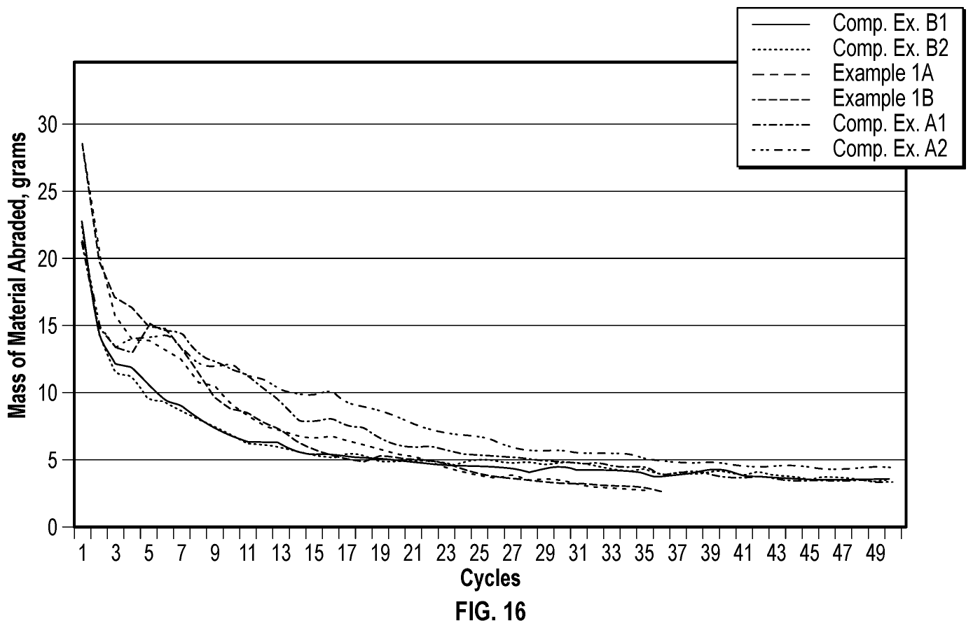

This test is designed to measure the effectiveness of an abrasive disc construction for the removal of metal from a workpiece by measuring how the cut-rate changes with time and the total amount of metal usefully removed over the life of the abrasive disc. The coated abrasive disc was mounted on a beveled aluminum back up pad and driven at a speed of 5500 rpm. A portion of the disc overlaying the beveled edge of the backup pad was contacted with the face of a 1.25 cm by 18 cm 1018 mild steel workpiece at about 6 kg load. Each disc was used to grind a separate workpiece for one-minute intervals (cycles) for a total of 20 minutes or until the disc failed or the cut rate dropped below 20 grams per minute. The amount of metal removed from each workpiece was recorded. The initial cut was reported as the amount of metal removed during the first one-minute interval. The final cut was reported as the amount of metal removed during the final one-minute interval. The total cut was the cumulative amount of metal removed from the workpieces over the entire useful life of the abrasive disc or 20 one-minute intervals, whichever was reached first. The cut data is reported in FIG. 16. in grams of workpiece metal removed as a function of abrading test grinding cycle. The example fiber disc coated with supported abrasive particles made in Example 1 show higher initial cut than that of Comparative Example A and Comparative Example B due to improved mineral orientation.

Materials used in Example 9 and Comparative Example C are reported in Table 3, below.

TABLE 3

| ABBRE- | |
|---|---|
| VIATION | DESCRIPTION |
| ACR | Trimethylolpropane triacrylate obtained as TMPTA from |
| | Allnex Inc., Brussels, Belgium |
| ALOX | Aluminum oxide conforming the FEPA (Federation of the |
| | European Producers of Abrasives) standard for P grade |
| | (P240 with 240+; P180 with 180+), obtained as BFRPL |
| | from Imerys Fused Minerals, Niagara Falls, New York |
| BYK-W985 | Solution of acidic polyester with sodium o-phenylphenate, |
| | obtained as BYK-W 985 from Altana AG, Wesel, Germany |
| CPI 6976 | Mixture of 4-thiophenylphenyl diphenyl sulfonium |
| | hexafluoroantimonate, and bis[4- |
| | (diphenylsulfonio)phenyl]sulfide |
| | bis(hexafluoroantimonate) in propylene carbonate, obtained |
| | as CPI 6976 from Aceto Corporation, Port Washington, |
| | New York |
| Devoflo | Calcium stearate dispersion available from EChem, Leeds, |
| 40CM X | United Kingdom |
| DOWICIL | Broad-spectrum biocide available as DOWICIL |
| QK-20 | Antimicrobials from Dow Chemical Company, Midland, |
| | Michigan |
| EP1 | Biphenol-A epoxy resin having an epoxy equivalent weight |
| | of 210-220 g/equiv., obtained as EPONEX 1510 from |
| | Momentive Specialty Chemicals, Inc., Columbus, Ohio |
| HL 27 | Non-silicone antifoam from Harcros Chemical Inc, St Paul, |
| | Minnesota |
| Irgacure | 2-hydroxy-2-methyl-1-phenyl-1-propan-1-one obtained as |
| 1173 | IRGACURE 1173 from BASF Corporation, Ludwigshafen, |
| | Germany |
| JC | Styrene-acrylic emulsion available as JONCRYL LMV |
| LMV7051 | 7051 from BASF Corporation |
| KATHON | Biocide available as KATHON CG/ICP from Dow |
| CG-ICP | Chemical Company, Midland, Michigan |
| Minex 10 | Anhydrous sodium potassium aluminosilicate obtained |
| | from Unimin Corporation, New Canaan, Connecticut |
| S9 | Purple pigment commercially available as 9S93 from Penn |
| | Color, Doylestown, Pennsylvania |

### Example 9

A make resin was prepared, according to the composition listed in Tables 4 and 5. The premix was prepared by mixing 70% EP1 and 30% ACR. To 55.40% of premix, 0.60% BYK-W985, 40% Minex 10, 3% CPI 6976, and 1% Irgacure 1173. The formulation was stirred for 30 minutes at 24° C. until homogeneous.

TABLE 4

| PREMIX | COMPOSITION, wt. % |
|---|---|
| EP1 | 70.00 |
| ACR | 30.00 |

TABLE 5

| MAKE RESIN COMPONENT | COMPOSITION, wt. % |
|---|---|
| Premix | 55.40 |
| BYK-W985 | 0.60 |
| Minex 10 | 40.00 |
| CPI 6976 | 3.00 |
| Irgacure 819 | 1.00 |

A size resin was prepared by premixing 70 wt. % of EP1 and 30 wt. % of ACR. To 55.06 wt. % of premium size premix, 0.59 wt. % of BYK-W985, 39.95 wt. % of Minex 10, 3 wt. % of CPI 6976, 1 wt. % of Irgacure 1173, and 0.40 wt. % of S9. The formulation was stirred for 30 minutes at 24° C. until homogeneous.

A calcium stearate-based supersize resin was prepared by mixing 74.7 wt. % of calcium stearate dispersion (Devflo 40CM X), 12 wt. % of styrene-acrylic emulsion (JC LMV7051), 0.3 wt. % of HL27, 0.13 wt. % of DOWICIL QK-20, and 0.07 wt. % of KATHON CG-ICP as biocides in 12.8 wt. % water using high speed mixer. The formulation was stirred at 24° C. until homogeneous.

3M Scotchpak film backing was coated with 10 g/m² of an epoxy-acrylate make resin. The coating was exposed to actinic radiation using a FUSION UV SYSTEMS processor with one set of D bulbs and one set of V bulbs both operating at 600 W/in (236 W/cm), converting the resin into a tacky, partially cured make coat. An abrasive particle blend containing 90% ALOX P400 and 10% supported abrasive particles made in Example 7 was then coated onto the make coat at a nominal coating weight of 29 g/m² using an electrostatic particle coater. The web was then exposed to infrared heaters at a nominal web temperature setting of 100° C., for about 7 seconds. The size resin was then roll coated onto the make layer and abrasive particles at a nominal dry coating weights of 29 g/m² and passed under a Fusion UV Systems (Gaithersburg, Md.) lamp with one set of H-bulbs, and two sets of D-bulbs, all three operating at 600 W/in (236 W/cm) for 5-10 sec. It was then processed through infrared ovens having a target exit web temperature of 125° C. for 5 mins. The supersize resin was then applied to the cured size layer a using roll-coat technique at coating weight of 10 g/m², which goes through the drying cycle at temperature setting of 60-90° C. zones. The resultant coated abrasive articles were then maintained at 20-24° C. and 40-60 percent relative humidity until tested. After drying, the strip of coated abrasive was converted into discs.

### Comparative Example C

The procedure described in Example 9 was repeated, with the exception that P400 ALOX was used instead of the supported abrasive particles made in Example 7.

### Abrasive Article Performance Testing for Example 9 and Comparative Example C

A 6 inch (15.24 cm) diameter abrasive disc to be tested were mounted on an electric rotary tool that was disposed over an X-Y table having an OEM panel sprayed with PPG primer secured to the X-Y table. A 3M Elite DA Sander with 3/16 servo was attached to the robotic arm. The tool was then set to traverse in the Y direction along the length of the panel; along the width of the panel. Seven such passes along the length of the panel were completed in each cycle for a total of 4 cycles. The rotary tool was then activated to rotate at 6000 rpm under no load. The abrasive article was then urged at an angle of 2.5 degrees against the panel at a load of 13 lbs (5.90 kg) of down force. The tool was then activated to move through the prescribed path. The mass of the panel was measured before and after each 1-minute cycle to determine the total mass loss in grams after each cycle. Cut was measured in grams removed from the clear coating layer of OEM panel. Total cut was measured by adding all four cut values from four abrasion cycles reported in Table 6, below. All reported data in Table 6 was based on average test results from 3 sample replicates.

TABLE 6

| | CUT | CUT | CUT | CUT | | RATIO of |
|---|---|---|---|---|---|---|
| | at | at | at | at | | Cut at cycle |
| | cycle | cycle | cycle | cycle | TOTAL | 4 to Cut at |
| EXAMPLE | 1, g | 2, g | 3, g | 4, g | CUT, g | cycle 1 |
| 9 | 6.63 | 6.62 | 6.23 | 5.98 | 25.46 | 0.90 |
| Comparative | 5.14 | 4.18 | 3.24 | 2.62 | 15.18 | 0.51 |
| Example C | | | | | | |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A plurality of supported abrasive particles wherein each supported abrasive particle respectively comprises an abrasive platelet member having a major surface and having at least one support member securely bonded to and proximate the major surface, wherein:
(i) the support member comprises a crushed abrasive particle;
(ii) the support member has a different composition than the abrasive platelet member; or (iii) both (i) and (ii).

2. The plurality of supported abrasive particles of claim 1, wherein the plurality of supported abrasive particles conform to an abrasives industry specified nominal grade.

3. The plurality of supported abrasive particles of claim 1, wherein the abrasive platelet member and the at least one crushed support member have the same composition.

4. The plurality of supported abrasive particles of claim 1, wherein the abrasive platelet member and the at least one crushed support member are sintered together.

5. The plurality of supported abrasive particles of claim 1, wherein the at least one crushed support member comprises two crushed support members.

6. The plurality of supported abrasive particles of claim 1, wherein the abrasive platelet member and the at least one crushed support member have different compositions.

7. The plurality of supported abrasive particles of claim 6, wherein the at least one crushed support member comprises a grinding aid.

8. The plurality of supported abrasive particles of claim 1, wherein the abrasive platelet member and the at least one crushed support member are bonded together with an adhesive.

9. The plurality of supported abrasive particles of claim 8, wherein the adhesive comprises an organic adhesive.

10. An abrasive article comprising the plurality of supported abrasive particles of claim 1 retained in a binder material.

11. An abrasive article according to claim 10, wherein the abrasive article comprises:
a backing;
a make layer disposed on the backing and retaining the plurality of supported abrasive particles; and
a size layer disposed over at least a portion the make layer and supported abrasive particles.

12. A method of making a supported abrasive particle, the method comprising:
providing a flowable abrasive precursor dispersion disposed in a shaped mold cavity and having an exposed surface;
contacting a support particle or precursor thereof with the exposed surface to make a precursor supported abrasive particle;
at least partially drying the precursor supported abrasive particle to provide a dried precursor supported abrasive particle;
removing the dried precursor supported abrasive particle from the shaped mold cavity; and
sintering the dried precursor supported abrasive particle to provide the supported abrasive particle.

13. The method of claim 12, further comprising humidifying the exposed surface prior to contacting it with the support particle.

14. The method of claim 12, wherein said contacting comprises electrostatically contacting.

15. The method of claim 12, wherein the support abrasive particle is a crushed abrasive particle.

16. A method of making a supported abrasive particle, the method comprising:
providing an abrasive platelet disposed on a substrate, wherein the shaped abrasive particle has an exposed major planar surface opposite the substrate;
providing a support particle having an adhesive layer disposed on at least a portion thereof;
bonding the adhesive to the exposed major planar surface and optionally hardening the adhesive to make the supported abrasive particle.

17. The method of claim 16, wherein the adhesive layer comprises a thermosetting organic material.

18. (canceled)

19. The method of claim 16, wherein the support particle comprises a crushed abrasive particle.

20. The method of claim 16, wherein the support member comprises a grinding aid particle.

21. The method of claim 16, wherein the support member comprises a shaped abrasive particle.
